(19) United States
(12) Patent Application Publication
(10) Pub. No.: US 2023/0226974 A1
(43) Pub. Date: Jul. 20, 2023

(54) Motor Vehicle Having an Acoustic Device for Generating and Capturing Acoustic Waves

(71) Applicant: Bayerische Motoren Werke Aktiengesellschaft, Muenchen (DE)

(72) Inventors: Viktor RACK, Pfaffenhofen a. d. Ilm (DE); Michael WUERTENBERGER, Hohenbrunn (DE)

(21) Appl. No.: 17/924,590

(22) PCT Filed: Apr. 15, 2021
(86) PCT No.: PCT/EP2021/059817

§ 371 Date: Nov. 10, 2022

(30) Foreign Application Priority Data
May 12, 2020 (DE) 10 2020 112 871.1

(51) Int. Cl. B60Q 5/00; G10K 11/178; G10K 15/04

(52) U.S. Cl. CPC B60Q 5/006; G10K 11/178; G10K 15/04; G10K 2210/1282; G10K 2210/129

(57) ABSTRACT

A motor vehicle includes an acoustic device configured to generate and capture acoustic waves, the acoustic device includes a vehicle part having a vibration region, and an actuator arranged thereon and configured to for excitation and detection of vibrations of the vehicle part in the vibration region, wherein the region is modified compared to an adjacent region of the vehicle part and has greater sensitivity to excitations in the frequency range of the acoustic wave.

### BACKGROUND AND SUMMARY

The present invention relates to a motor vehicle having an acoustic device for generating and for capturing audible sound.

With the ever further advancing development and spread of driving-assistance systems and also of semi-autonomous and autonomous driving functions at present, a capture of the neighborhood of a respective motor vehicle that is as complete as possible—or, to be more exact, a sensing system serving as a basis for automated functions—is also increasingly gaining in significance. In this context, a networking of road users with one another, or of the respective motor vehicle with its neighborhood or environment, is also playing an increasingly more important role, in order to obtain further enhanced safety and reliability as well as further enhanced comfort for all road users involved. For this purpose, the use of cameras, luminous elements, radar devices, lidar devices and suchlike is already known from diverse examples.

As a further approach, DE 10 2018 201 085 A1 describes a sound-generating safety system for a motor vehicle with a view to the acoustic perceptibility thereof from outside. The system comprises several sound-generators which are designed both for generating a sound that is perceptible outside the motor vehicle and for monitoring the sound generated by the sound-generators. The sound-generators are intended to be operated temporarily and/or alternating with one another in an appropriate sensor mode and, depending on a monitoring signal captured in the process, in an appropriate sound-generating mode.

The object of the present invention is to enhance safety in the course of operation of a motor vehicle. In accordance with the invention, this object is achieved by the subject-matters of the independent claims. Advantageous refinements and developments of the present invention are specified in the dependent claims, in the description and in the Figures.

A motor vehicle according to the invention exhibits at least one acoustic device for generating and for capturing audible sound. The term “audible sound” in this sense designates sound-waves or acoustic waves, the frequency of which lies within the human capacity for sound-perception or hearing—that is to say, for instance, within the range from 10 Hz to 20 kHz. For this purpose, the acoustic device includes a vehicle part of the motor vehicle with an oscillation region and with an actuator arranged thereon for exciting and detecting oscillations of this vehicle part in the oscillation region—that is to say, for exciting and detecting oscillations of this oscillation region. The oscillation region in the present sense is accordingly not a frequency range, but rather this term designates a physical surface region of the vehicle part. The oscillation region has been modified—that is to say, configured or machined differently in at least one respect—in comparison with, or relative to, a region of the respective vehicle part adjoining or surrounding the oscillation region, and, as a result, exhibits greater sensitivity in respect of excitations or oscillations within the frequency range of audible sound.

The vehicle part may preferably be an exterior part of the motor vehicle—for instance, a body part or attachment. The vehicle part may accordingly be, for instance, part of a sheet-metal skin or of a plastic fairing, a skirt or a spoiler of the motor vehicle, or suchlike. But the vehicle part may equally be an interior component—that is to say, an inner or internal part of the motor vehicle, for instance an interior-paneling component or interior-furnishing component.

In each case, the actuator may preferably have been arranged on a respective inside of the vehicle part. In other words, the actuator may have been concealed by the vehicle part—viewed from outside or in relation to a neighborhood of the motor vehicle—if the vehicle part is an exterior part. If, on the other hand, the vehicle part is an interior component, the actuator may have been concealed by the interior component from an interior space or passenger compartment of the motor vehicle—that is to say, in relation to this passenger compartment. By virtue of such an inner or internal—that is to say, concealed—arrangement of the actuator, on the one hand the greatest possible design freedom or flexibility of styling can be preserved. On the other hand, the actuator is protected by the respective vehicle part against damage, as a result of which the reliability of the acoustic device can be enhanced.

According to the present invention, the acoustic device can act as a loudspeaker by active excitation of the vehicle part—or, to be more exact, of the oscillation region—to execute acoustic oscillations. Similarly, the acoustic device can act as a microphone or sensor by capturing or picking up oscillations, airborne sound, structure-borne sound or vibrations transmitted to the vehicle part, or, to be more exact, by the capture or detection thereof by means of the actuator. By virtue of the acoustic device, two functions are accordingly put into effect. By virtue of such a multifunctional configuration and use of the acoustic device, an additional microphone or an additional loudspeaker, for instance, can be dispensed with. This enables a reduction of the complexity, cost, component provision and also weight of the motor vehicle.

If, in particular, the vehicle part is an exterior part of the motor vehicle, a 2-way communication—that is to say, a bidirectional communication within the range of audible sound—with the neighborhood of the respective motor vehicle—that is to say, for instance, with other road users or other persons or personnel—is accordingly made possible. Such a communication can contribute in highly diverse ways to an enhancement of safety in traffic, and also to enhancing the comfort of vehicle occupants and persons external to the vehicle. Concrete examples of this will be elucidated in still more detail further below.

By virtue of the possibility of capturing sound-waves from the neighborhood of the motor vehicle by means of the acoustic device, the acoustic device constitutes an ambient sensing system which operates within a frequency range or signal range that typically has not been covered hitherto by conventional ambient sensing systems. Hence the present invention can accordingly contribute to a more comprehensive automatic detection of the neighborhood, as a result of which autonomous or semi-autonomous driving functions or assistance functions can be carried out more reliably and more safely.

For the purpose of operating the acoustic device, the actuator may have been connected up to, for instance, an on-board power supply of the motor vehicle. Via this power supply, the actuator can, for instance, be supplied with energy, and/or control signals can be communicated to the actuator, and/or measurement signals detected—that is to say, picked up—by means of the actuator can be transmitted, for instance, to a signal-processing or data-processing device. The actuator may, for instance, be electromagnetically operated.

By virtue of the fact that the oscillation region has been modified in comparison with the adjacent region of the vehicle part, an oscillation behavior or frequency response of the oscillation region can be set particularly accurately. This enables the flexible use of a plurality of different vehicle parts, even if in their conventional—that is to say, non-modified—form they do not exhibit sufficient sensitivity in respect of excitations within the range of audible sound. Depending on the respective vehicle part, the oscillation region may take up or make up a relatively small part or region of the respective vehicle part. The use of the respective vehicle part as part of the acoustic device can consequently be made possible without, for instance, influencing or weakening the stability or general stiffness of the respective vehicle part. In addition, by virtue of the modification of the oscillation region, where appropriate the entire vehicle part can be prevented from being excited to execute oscillations within the range of audible sound. As a result, a diminution of the service life or, to be more exact, of the durability or reliability of the motor vehicle can be avoided, despite the use of the acoustic device proposed in the present case. There are various possibilities for modifying the oscillation region in the present sense, some of which will be elucidated in more detail further below.

In advantageous refinement of the present invention, for the purpose of modifying the oscillation region the latter has been formed from a different material than the adjacent region of the vehicle part. Additionally or alternatively, the oscillation region has a different material thickness—that is to say, a different thickness, measured, for instance, perpendicular to a principal surface of extent of the respective vehicle part—than the adjacent region of the vehicle part. In particular, the material thickness of the oscillation region may be smaller than in the adjacent region. If the oscillation region is formed or manufactured at least partially from a different material or with a different material composition than the adjacent part, a density or an area weight, for instance, of the oscillation region can be adapted, in order to set a sensitivity desired in the given case with respect to excitations within the range of audible sound, or to set a particular oscillation behavior of the oscillation region. By virtue of these configurations of the oscillation region, the sensitivity thereof in respect of excitations within the range of audible sound—that is to say, the oscillation behavior or frequency response thereof—can be set selectively and particularly accurately. As a result, a particularly accurate and reliable capture of audible-sound excitations of the oscillation region is ultimately made possible, as well as a particularly simple and efficient active excitation of the oscillation region.

In further advantageous refinement of the present invention, the oscillation region exhibits several structures or partial regions having different resonant frequencies. The oscillation region may accordingly have been divided up, for instance, into partial regions or surface regions separated or spaced from one another at least partially or zonally. These partial regions may, for instance, be of different sizes, may have been formed from different materials, may have different material compositions and/or material thicknesses, and/or may differ from one another in some other way. A structure or structuring for, or with, differing resonant frequencies may, for instance, have a width and/or thickness varying over its length, a spiral or helical shape, or suchlike. Such a structure may, for instance, have been embossed or milled into the oscillation region, integrated into the oscillation region or applied thereto, or suchlike. In other words, the oscillation region may accordingly have been designed for resonant excitation at differing frequencies. As a result, the sensitivity and dynamics of the oscillation region can advantageously be set or enhanced over a particularly wide frequency range. This, in turn, can enable a particularly reliable and detailed generation and capture of audible sound, and consequently can ultimately further enhance the functioning and the other described advantages and properties of the acoustic device.

In advantageous development of the present invention, the partial regions take the form of surface regions of the oscillation region of differing sizes and/or separated from one another by structural elements of differing lengths. The structural elements may be, in particular, recesses or struts. Such recesses may be, for instance, slits completely penetrating the material of the oscillation region, or merely recesses or grooves in which the material thickness of the oscillation region has been reduced in comparison with its immediate neighborhood—that is to say, the partial regions. Struts may be, for instance, additional components or elements that have been applied to the oscillation region or entirely or partially embedded or integrated into it. Similarly, the struts may be, for instance, volume regions of the oscillation region that have been formed from a different material or have a different material composition than their respective immediate neighborhood—that is to say, respective adjacent partial regions of the oscillation region. The structural elements may, in particular, have an elongated or rod-like shape. The oscillation region may preferably have an at least substantially round or circular-disc-like shape, in which case the structural elements may then preferably extend or have been arranged in the radial direction. It has been shown that the use of such structural elements for generating the partial regions constitutes a particularly simple and practicable possibility for realizing differing resonant frequencies of the oscillation region.

In further advantageous refinement of the present invention, the motor vehicle exhibits several acoustic devices and a data-processing device connected thereto. The data-processing device has been set up to generate a characterization of at least a part of the neighborhood of the motor vehicle on the basis of a combination of acoustic signals captured by means of various of the acoustic devices. In particular, the data-processing device may have been set up to set in proportion to one another acoustic signals originating from, or captured by, various acoustic devices, and/or to carry out a cross-correlation of these acoustic signals and accordingly to compute them.

In the present case, the acoustic devices and the data-processing device accordingly constitute a network in which a particular acoustic signal can be captured by various of the acoustic devices, for instance at differing times and/or with differing intensities or strengths. By automatic evaluation of these differences—that is to say, by appropriate automatic signal processing—an ambient image can then be generated. For instance, a direction or a range of a respective sound-source that sent out the captured acoustic signal can be determined or at least estimated automatically. Such an ambient image—or, to be more exact, such a characterization of the neighborhood of the motor vehicle—can then be used advantageously as a basis for highly diverse—in particular, automatic or automated—control systems or functional layouts of the motor vehicle. For this purpose, the corresponding characterization—that is to say, for instance, the direction or range or some other particular property of the sound-source—can be output or provided via an output interface of the data-processing device. Similarly, the data-processing device itself can generate and output appropriate control signals for one or more components or assistance systems of the motor vehicle—that is to say, it can trigger the components or systems appropriately.

It may be possible, for instance, to infer—that is to say, to determine or to estimate—a manner or type and/or motion of the respective sound-source automatically on the basis of a spectrum or a signal shape of the respective acoustic signal or the temporal evolution thereof. If, for instance, a predetermined minimal range of the sound-source from the motor vehicle is then fallen short of, or a predetermined relative motion between the motor vehicle and the sound-source is detected, the motor vehicle can, for instance, be brought to a standstill or diverted automatically, in order to avoid a collision with the sound-source.

In further advantageous refinement of the present invention, the acoustic device has been set up to capture a state and/or a planned behavior of the motor vehicle and to generate a respective acoustic signal as a function thereof and to output it to, or into, the neighborhood of the motor vehicle. This acoustic signal specifies the captured state and/or the captured planned behavior and can accordingly convey or communicate this state or this behavior to the neighborhood. Also by this means, safety and comfort in road traffic can be enhanced, since, for instance, an incorrect assessment of the current state and/or of the current or future behavior of the motor vehicle can be made difficult for other road users—in particular, for pedestrians or cyclists—in the neighborhood of the motor vehicle. For instance, the motor vehicle—or, to be more exact, the respective acoustic signal—can signal to another road user that the other road user has been detected by the motor vehicle, and the motor vehicle will accordingly stop in time or swerve in a particular direction in order to avoid a collision. As a result, it can be signaled to a pedestrian, for instance, that he/she can safely cross, ahead of the motor vehicle, a road being driven along by the motor vehicle. The functionality proposed herein may be particularly advantageous, in particular, for autonomous motor vehicles or in an autonomous driving mode of the motor vehicle, as well as for electrically powered motor vehicles, since many road users nowadays are not yet familiar with corresponding automated modes of behavior of such motor vehicles, and electrically powered motor vehicles are more difficult to assess correctly on the basis of their operating noise than conventional motor vehicles.

If the motor vehicle is, for instance, a taxi—in particular, an autonomous taxi—or a vehicle of a passenger-carrying service, the state—or, to be more exact, the corresponding acoustic signal—can inform persons waiting, for instance, in the neighborhood of the motor vehicle whether the motor vehicle is vacant—that is to say, available—or whether it is intended for the respective waiting person, and/or suchlike. Similarly, the acoustic signal can simulate or convey, for instance, an engine noise or operating noise of the motor vehicle. By appropriate fashioning or modulation of the acoustic signal, it can then be signaled—by way of state of the motor vehicle, for instance—that the motor vehicle is slowing down or accelerating. This may be especially advantageous, particularly when the motor vehicle is an electrically powered vehicle. Finally, safety and/or comfort, for instance, for inattentive, visually impaired or blind people in road traffic can be enhanced significantly and particularly easily by means of the acoustic signal—or, to be more exact, the indication or signaling of the state and/or the planned behavior of the motor vehicle achieved thereby. For this purpose, the acoustic signal may be configured in differing ways, for instance as engine noise or operating noise, as a signal tone or a succession of signal tones, as a melody, as an individual or adapted code—for instance, agreed with a particular person—and/or suchlike. The acoustic signal may preferably have been standardized in predetermined manner for particular states and/or particular planned behaviors. As a result, a communication of the state or of the behavior is made possible particularly easily.

In further advantageous refinement of the present invention, the acoustic device has been set up to emit—that is to say, to send out—a voice signal by active triggering of the actuator. In other words, the acoustic device has accordingly been designed to generate a voice output—or, to be more exact, to output speech—in particular into the neighborhood of the motor vehicle by causing the oscillation region to execute appropriate acoustic oscillations. For this purpose, the acoustic device may include, for instance, an appropriately configured control unit connected to the actuator. This control unit may be, for instance, the stated data-processing device or a part thereof, or may include it. The statement that the acoustic device has been set up appropriately may signify here, for instance, that the acoustic device has been designed to generate the voice signal as regards its dynamics, its modulation capability, its size, its stability, its oscillation capability, and/or suchlike. For this purpose, the respective oscillation region may, for instance, have been designed to be appropriately thin, lightweight and/or zonally varying, in order to enable a sufficiently rapid modulation and a generation of sound over a sufficient frequency range. The configuration of the acoustic device proposed herein can enable a particularly effective and detailed communication with the neighborhood of the motor vehicle—or, to be more exact, with persons lingering in the neighborhood. Accordingly, the intelligibility, or the correct interpretation, of the acoustic signals generated by means of the acoustic device can, for instance, be enhanced.

In further advantageous refinement of the present invention, the acoustic device has been set up to detect a collision of the motor vehicle with an obstacle external to the vehicle on the basis of an externally induced motion of the vehicle part, captured by means of the actuator. An externally induced motion of the vehicle part is a motion or oscillation of the vehicle part that has not been caused by active triggering of the actuator—that is to say, not caused by active excitation of the vehicle part by means of the actuator. In the present case, an amplitude of the motion and/or a speed of motion of the vehicle part, for instance, can be captured or determined automatically. Similarly, it can, for instance, be determined automatically whether the motion of the vehicle part—that is to say, a corresponding oscillation or vibration—is captured only by the one acoustic device or alternatively by one or more further acoustic devices of the motor vehicle, for how long the motion lasts, how the motion develops temporally, and/or suchlike. On the basis of this and/or, for instance, by comparison with appropriate predetermined criteria or patterns for motions indicating a collision, it can then be determined or estimated automatically whether or not the motion was caused by a collision. If a collision is detected on the basis of the motion of the vehicle part, an appropriate control signal can be generated and output automatically, for instance by the aforementioned control unit or the aforementioned data-processing device. As a result, the motor vehicle can be stopped automatically, for instance, and/or a further motion of the motor vehicle in the direction of the obstacle can be prevented, which can likewise enhance safety in the course of operation of the motor vehicle.

In further advantageous refinement of the present invention, the acoustic device has been set up to capture interfering noises—that is to say, undesirable motions or vibrations of the vehicle part—and to counteract these noises by appropriately antiphase triggering of the actuator. By virtue of this triggering of the actuator, in particular an amplitude of the respective interfering noises, or of the corresponding vibrations of the vehicle part, can accordingly be diminished. Corresponding interfering noises may be, for instance, ambient noises, driving noises or operating noises of the motor vehicle. By virtue of the triggering, proposed herein, of the actuator—or, to be more exact, of the acoustic device—a loudness-level of the motor vehicle or, to be more exact, in a passenger compartment of the motor vehicle, can accordingly be diminished and/or modified in its frequency spectrum. As a result, the acoustic comfort of the motor vehicle can be enhanced. In addition, by diminishing or suppressing the corresponding vibrations of the vehicle part, damage to, or wear of, the motor vehicle, for instance at retaining or connecting points of the vehicle part, can be avoided or diminished. Similarly, by virtue of the capturing of the vibrations of the vehicle part, damage to, or wear of, the motor vehicle can possibly be detected. If this is the case, a corresponding control signal or information signal can then be generated and output, for instance automatically, in order to enable a reliable maintenance of the motor vehicle. Here too, for an appropriate detection or diagnosis the captured vibrations can, for instance, be compared with predetermined patterns, signals or spectra, in order to make a distinction possible between vibrations caused inside the vehicle and vibrations of the vehicle part caused outside the vehicle—that is to say, vibrations excited from the neighborhood of the vehicle. The acoustic device or several appropriate acoustic devices can be used particularly effectively and inexpensively also for this functionality, since appropriate acoustic devices can be arranged on a plurality of vehicle parts that typically have not been monitored hitherto by specific sensors and, by reason of their multi-functionality, constitute a particularly cost-efficient and resource-efficient solution.

In further advantageous refinement of the present invention, the acoustic device has been set up to adapt its sensitivity for the purpose of capturing audible sound—in particular, externally induced audible sound—automatically, depending on the current driving speed of the motor vehicle in the given case. The sensitivity is reduced automatically at a higher speed and increased automatically at a lower speed. As a result, the full sensitivity of the acoustic device can be utilized at appropriately low speeds, for instance below 50 km/h or below 30 km/h, whereas at higher speeds, for instance above 50 km/h or above 70 km/h, practically inevitable noises or vibrations due to the correspondingly lowered sensitivity can be filtered out. These may be, for instance, noises or vibrations of the vehicle part caused by a wind due to speed though the air, which do not carry any information content whatever. In this way, the efficiency of the acoustic device can be optimized, and a processing of the signal can be simplified. For the purpose of adapting the sensitivity, one or more speed threshold values and/or an adaptation rule may have been predetermined. The latter may provide or predetermine, for instance, a continuous or quasi-continuous speed-dependent adaptation of the sensitivity. This advantageously enables a tuning of the acoustic device on demand, depending upon the application or the neighborhood.

Similarly, a location-dependent adaptation, for instance, of the sensitivity may have been provided. For this purpose, one or more locations or types of location may have been predetermined, at which the sensitivity is reduced or is to be reduced. In this way, the sensitivity can, for instance, be reduced automatically when driving along a highway or a country road, in particular at a speed above a predetermined speed threshold value, in a car wash, or suchlike. As a result, an ultimately unnecessary capture of oscillations or vibrations of the vehicle part can be avoided.

Further features of the invention may arise out of the claims, the Figures, and the description of the Figures. The features and feature combinations mentioned above in the description, and also the features and feature combinations shown below in the description of the Figures, and/or in the Figures alone, are capable of being used not only in the combination specified in the given case but also in other combinations or on their own, without departing from the scope of the invention.

### BRIEF DESCRIPTION OF THE DRAWINGS

FIG. 1 shows a schematic top view of a motor vehicle with acoustic elements, and an obstacle external to the vehicle;

FIG. 2 shows a schematic sectional top view of a vehicle part with two acoustic elements; and

FIG. 3 shows a schematic sectional side view of the vehicle part.

### DETAILED DESCRIPTION

In the Figures, identical and functionally identical elements have been provided with the same reference symbols.

Particularly in the field of autonomous driving, there currently exists heightened interest in capturing the environment—that is to say, a respective vehicle neighborhood—also via audio signals—that is to say, within the range of audible sound—for instance in order to detect or to identify concealed sources of danger as early as possible. The use of classical microphones on an outside of a vehicle quickly comes up against its limitations, since such microphones are susceptible to, for instance, wind noises in such a manner that sound from sound-sources relevant to safety is drowned out in the wind noises and, as a result, cannot be detected reliably.

Communication between motor vehicles and environment or neighborhood is also increasingly gaining in significance precisely also in the field of autonomous or automated driving. An advantageous possibility here consists, in particular, in audio communication between vehicle and environment—that is to say, within the frequency range of audible sound.

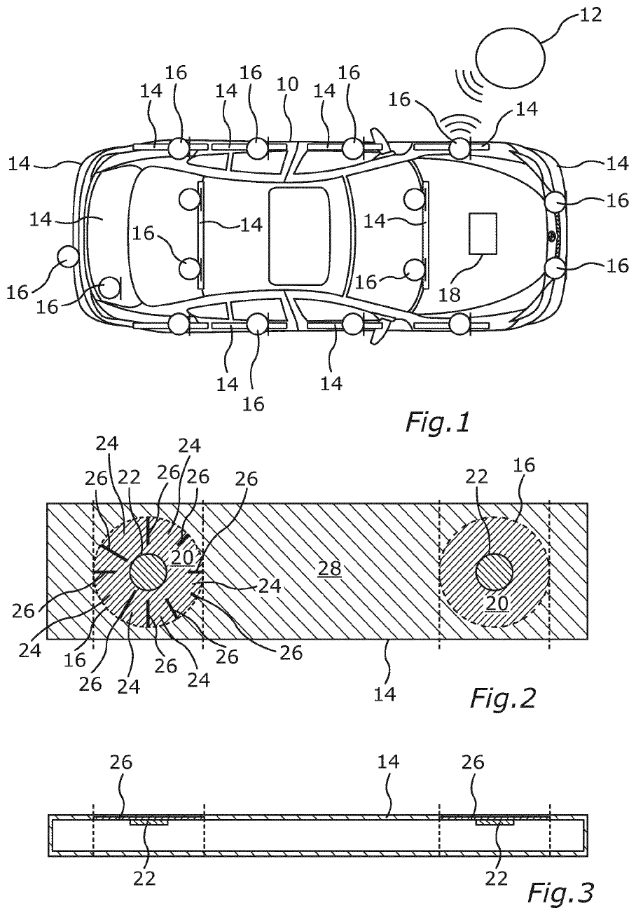

FIG. 1 shows a schematic overview representation of an appropriately equipped motor vehicle 10 and also of an obstacle 12 external to the vehicle. This obstacle 12 may be, for instance, another road user. For the purpose of audible-sound-based communication with the neighborhood—that is to say, for the purpose of generating and capturing audible sound—the motor vehicle 10 in the present case exhibits an acoustic device. For this purpose, respective acoustic elements 16 have been formed on a plurality of vehicle parts 14, the acoustic elements being connected to a central control unit 18, for instance via an on-board power supply, not represented in any detail here, of the motor vehicle 10. The vehicle parts 14 may be, for instance, plastic parts of a body, a front or rear skirt, body attachments, a rear spoiler, mirror covers, a leaf-catcher, or suchlike. The vehicle parts 14 may have been formed from various materials, such as, for instance, plastic, metal, alloys, composite or laminated materials, glass, or suchlike.

The vehicle parts 14 have been modified in the region of the acoustic elements 16 in comparison with a respective adjacent region of the respective vehicle part 14, in order to obtain greater sensitivity in respect of excitations within the frequency range of audible sound. The acoustic elements 16 have been arranged in these regions and may include, for instance, a respective sensor actuator, here designated for short as an actuator 22 (see FIG. 2). Hence the vehicle parts 14—or, to be more exact, the appropriately modified regions—can be excited to execute audible-sound oscillations, and corresponding oscillations or vibrations can be captured—that is to say, detected—by means of the sensor actuator.

The acoustic elements 16 and the control unit 18 here have been connected to form a sensor network or acoustic network, as a result of which diverse advantageous evaluation possibilities or signal-processing possibilities arise or are afforded.

In the present case, by means of the acoustic device—which here accordingly includes the acoustic elements 16, at least parts of the vehicle parts 14 and the control unit 18—the obstacle 12 external to the vehicle, for instance, can be detected on the basis of sound-waves emitted by the obstacle and captured by means of the acoustic elements 16. Similarly, by means of one or more of the acoustic elements 16 an acoustic signal can be output into the neighborhood, in particular to the obstacle 12, by appropriate excitation of at least a part of the respective vehicle part 14. For instance, in the region of a crosswalk the obstacle 12 may be a pedestrian. The pedestrian can then, for instance, indicate to the motor vehicle 10 that he/she wishes to go across the crosswalk, for instance by saying: “Stop! I want to cross the road”. The motor vehicle 10 can capture this and react to it by means of the acoustic device, for instance by output of a confirmatory voice output such as “I have noticed you and shall remain stationary until you have gone past.”

FIG. 2 shows a schematic top view of one of the vehicle parts 14 with two acoustic elements 16 by way of example. In the present case, the vehicle part 14 represented here may be, for instance, a roof spoiler of the motor vehicle 10. The acoustic elements 16 here each include an oscillation region 20 which has been modified as regards its oscillation behavior in comparison with a remainder—or, to be more exact, an adjacent region 28—of the vehicle part 14. In each instance, an actuator 22 for exciting and for capturing oscillations of the respective oscillation region 20 has been arranged centrally in these oscillation regions 20.

In the configuration represented here by way of example, the oscillation region 20 of one of the two acoustic elements 16 has been divided up into several partial regions 24 which have differing sizes and consequently differing resonant frequencies. The partial regions 24 have been delimited from one another by structural elements 26 extending in the radial direction.

FIG. 3 shows a schematic sectional side view of the vehicle part 14 from FIG. 2—here, by way of example, the roof spoiler of the motor vehicle 10. It can be discerned here that the acoustic elements 16, in particular the actuators 22, have been arranged on an inside of the vehicle part 14 and are consequently concealed and protected by the vehicle part 14.

The acoustic elements 16 here have accordingly been directly fastened to a vehicle structure of the motor vehicle 10, or integrated therein, and have been designed for optimizing the respective oscillation behavior or for selective setting thereof, taking respective material structures and material properties into consideration.

The use of the vehicle parts 14 or, to be more exact, of the oscillation regions 20 formed in the vehicle parts 14—that is to say, body parts or attachments that, after all, are already present on the motor vehicle 10—for the purpose of generating and capturing the sound has the advantage that these regions or parts are distinctly less susceptible to interference than conventional diaphragm-based microphones. As a result, fewer failures and correspondingly less maintenance effort arise, so that enhanced reliability and hence ultimately enhanced safety are accordingly afforded. In addition, in comparison with conventional diaphragm microphones further functions can be realized—for instance, a sensing of vibrations within the vehicle, transmitted to the respective vehicle part 14 via structure-borne sound, for instance. Similarly, collisions or minor damage associated with parking, or suchlike, can be detected by means of the acoustic device, and a respective user or operator of the motor vehicle 10 can be informed thereof. Similarly, the acoustic device presented herein can also be employed during a trip of the motor vehicle 10 both for self-protection and for protection of the surrounding field or of other road users, for instance by means of an appropriate acoustic warning to other road users.

The generation and capture of audible sound is, in principle, already possible with a single acoustic element 16. However, the use of several acoustic elements 16, particularly in an interconnected system or network, is advantageous. In this way, various directions can be exposed to sound particularly accurately and reliably, and audible sound from various directions can be captured, in particular in respect of all horizontal directions—that is to say, within a 360° angular range or circumscribed circle in the x-y plane of the motor vehicle 10. For instance, an acoustic image of the neighborhood can be computed by cross-correlation of the acoustic elements 16—or, to be more exact, of the acoustic signals captured by the acoustic elements—with one another, and/or by forming a ratio of corresponding captured acoustic signals or measured values. In this sense, the network of the acoustic elements 16 can accordingly act intuitively like a type of acoustic camera. Precisely in an urban surrounding field, the range of audible sound—that is to say, the acoustic range from about 10 Hz to about 20 kHz—may be particularly important and may provide particularly valuable information.

In this connection, the intelligent placement, integration and adaptation of the acoustic device, in particular of the acoustic elements 16, to the vehicle parts 14 is particularly advantageous, particularly with appropriate modification or adaptation of the vehicle parts 14, bearing in mind the respective material properties as regards oscillation excitations within the higher range of audible sound.

An optimal positioning or placement and/or the respective configuration of the acoustic elements 16—or, to be more exact, of the oscillation regions 20—can be optimized in advance, for instance by appropriate modeling or simulation, for instance as regards a maximized sensitivity, a frequency behavior adapted on demand, an excitation efficiency, a stability or stiffness of the respective vehicle part 14, and/or suchlike.

The acoustic device described herein offers a number of advantages and advantageous applications. For instance, a respective customer can utilize the acoustic device as a man/machine interface for communicating with the motor vehicle 10 within the scope of so-called on-demand mobility or when using automated or autonomous taxis, or suchlike. Similarly, other personnel—for instance, a police officer or suchlike—can communicate with the optionally unmanned motor vehicle 10 via the acoustic device. If the motor vehicle 10 is being remote-controlled by a teleoperator, the neighborhood of the motor vehicle 10 can be made audible for the teleoperator by means of the acoustic device, as a result of which a better assessment of a respective situation is made possible for the teleoperator. In addition, the teleoperator can communicate actively with the neighborhood via the acoustic device.

Similarly, material fatigue or damage, for instance, can be detected by means of the acoustic device on the basis of a detected change in an oscillation behavior of the vehicle parts 14 over time, or a failure can be predicted, for instance on the basis of a particular pattern or a particular change in a resonant frequency or fundamental oscillation of the respective vehicle part 14. This can be advantageous, in particular, when at least one of the acoustic elements 16 has been arranged on a supporting structure of the motor vehicle 10. On the basis of corresponding data, where appropriate a failure or complete breakdown of the motor vehicle 10 or of a vehicle part 14 can then be detected in good time and prevented by appropriate maintenance measures.

Similarly, interfering noises—which may arise, for instance, by virtue of body parts of the motor vehicle 10 in the course of a trip, by virtue of vibrations, wind due to speed though the air, and/or other units of the motor vehicle 10—can be captured by means of the acoustic device. By means of the acoustic device—or, to be more exact, the actuators 22—a phase-offset or negative oscillation relative to the respective interfering noise can then be generated and superimposed thereon, in order to counteract the interfering noises.

The acoustic device can also be employed for the purpose of generating engine-replacement noises, particularly in the case of electric vehicles, without additional loudspeakers or sound modules or suchlike, for instance, being necessary for this purpose. In this connection, differing engine-replacement noises, for instance, can be generated, depending upon the state or a planned behavior of the motor vehicle 10. In an autonomous taxi mode of the motor vehicle 10, for instance, by virtue of appropriately differing noises generated by means of the acoustic device it can be signaled—respectively captured by other persons—whether the motor vehicle 10 is currently free or occupied, is approaching the respective person or moving away from the latter, and/or suchlike.

Overall, the described examples show how an acoustic communication in and with the surrounding field of a vehicle can be realized by an intelligent application of 2-way oscillation pickups on body components and structural components of a vehicle.

### LIST OF REFERENCE SYMBOLS

10 motor vehicle
12 obstacle
14 vehicle parts
16 acoustic elements
18 control unit
20 oscillation region
22 actuator
24 partial regions
26 structural elements
28 adjacent region

1-10. (canceled)

11. A motor vehicle comprising:
an acoustic device configured to generate and capture audible sound, the acoustic device comprising:
a vehicle part with an oscillation region; and
an actuator arranged on the vehicle part and configured to excite and detect oscillations of the vehicle part in the oscillation region, wherein the oscillation region is modified in comparison with an adjacent region of the vehicle part to exhibit greater sensitivity in respect to excitations within an audible sound frequency range.

12. The motor vehicle according to claim 11, wherein
the oscillation region is formed from a different material and/or has a different material thickness than the adjacent region of the vehicle part.

13. The motor vehicle according to claim 10, wherein
the oscillation region comprises a plurality of structures or partial regions having differing resonant frequencies.

14. The motor vehicle according to claim 13, wherein
the plurality of partial regions comprise surface regions of the oscillation region which have differing sizes and/or are separated from one another by structural elements of differing lengths, the structural elements comprising recesses or struts.

15. The motor vehicle according to claim 11, further comprising:
a plurality of acoustic devices; and
a data-processing device connected to the plurality of acoustic devices, the data-processing device configured to generate a characterization of a neighborhood of the motor vehicle on a basis of a combination of acoustic signals captured by means of various ones of the plurality of acoustic devices.

16. The motor vehicle according to claim 11, wherein
the acoustic device is configured to capture a state and/or a planned behavior of the motor vehicle and to generate, as a function thereof, a respective acoustic signal that specifies the captured state and/or the captured planned behavior, and to output the respective acoustic signal to a neighborhood of the motor vehicle.

17. The motor vehicle according to claim 11, wherein
the acoustic device is configured to emit a voice signal by active triggering of the actuator.

18. The motor vehicle according to claim 11, wherein
the acoustic device is configured to detect a collision of the motor vehicle with an obstacle external to the vehicle on a basis of an externally induced motion of the vehicle part, captured by means of the actuator.

19. The motor vehicle according to claim 11, wherein
the acoustic device is configured to capture interfering noises of the vehicle part and to counteract the interfering noises by antiphase triggering of the actuator.

20. The motor vehicle according to claim 11, wherein
the acoustic device is configured to adapt its sensitivity to capture audible sound automatically as a function of a current driving speed of the motor vehicle, wherein the acoustic device is further configured to reduce the sensitivity at a higher speed and increase the sensitivity at a lower speed.

21. The motor vehicle according to claim 15, wherein
the data-processing device is configured to generate the characterization of the neighborhood of the motor vehicle on a basis of a cross-correlation and/or formation of a ratio of the acoustic signals.

22. The motor vehicle according to claim 15, wherein
the acoustic device is configured to capture a state and/or a planned behavior of the motor vehicle and to generate, as a function thereof, a respective acoustic signal that specifies the captured state and/or the captured planned behavior, and to output the respective acoustic signal to a neighborhood of the motor vehicle.

23. The motor vehicle according to claim 15, wherein
the acoustic device is configured to emit a voice signal by active triggering of the actuator.

24. The motor vehicle according to claim 15, wherein
the acoustic device is configured to detect a collision of the motor vehicle with an obstacle external to the vehicle on a basis of an externally induced motion of the vehicle part, captured by means of the actuator.

25. The motor vehicle according to claim 15, wherein
the acoustic device is configured to capture interfering noises of the vehicle part and to counteract the interfering noises by antiphase triggering of the actuator.

26. The motor vehicle according to claim 15, wherein
the acoustic device is configured to adapt its sensitivity to capture audible sound automatically as a function of a current driving speed of the motor vehicle, wherein the acoustic device is further configured to reduce the sensitivity at a higher speed and increase the sensitivity at a lower speed.
